(19) United States
(12) Patent Application Publication
(10) Pub. No.: US 2020/0002519 A1
(43) Pub. Date: Jan. 2, 2020

(54) RUBBER COMPOSITION AND PAPER FEEDING ROLLER FORMED OF THE SAME

(71) Applicant: SUMITOMO RUBBER INDUSTRIES, LTD., Hyogo (JP)

(72) Inventors: MASASHI HAMAKUBO, Hyogo (JP); HIROFUMI KONISHI, Hyogo (JP); YUDAI OKUNO, Hyogo (JP)

(73) Assignee: SUMITOMO RUBBER INDUSTRIES, LTD., HYOGO (JP)

(21) Appl. No.: 16/365,686

(22) Filed: Mar. 27, 2019

(30) Foreign Application Priority Data
Jun. 28, 2018 (JP) 2018-123558

(51) Int. Cl. C08L 23/16; B65H 3/06

(52) U.S. Cl. CPC C08L 23/16; B65H 3/0638; C08L 2205/025; G07D 11/16; C08L 2205/03; B65H 2515/81; C08L 2312/00

(57) ABSTRACT

Provided are a rubber composition which is a base of a roller main body and capable of imparting favorable flexibility to the roller main body while maintaining high abrasion resistance to form, for example, a paper feeding roller that has a favorable paper feeding performance and can be used as a paper supply roller or the like; and a paper feeding roller in which the roller main body is formed using the rubber composition. There is provided a rubber composition contains a rubber that includes 20 to 80 parts by mass of a non-oil extended EPDM having an ethylene content of 55% to 72%, and an oil extended EPDM; and 20 parts by mass or less of a filler and 2.5 parts by mass or more of a peroxide crosslinking agent per 100 parts by mass of the rubber.

### CROSS-REFERENCE TO RELATED APPLICATION

This application claims the priority benefit of Japanese Application Serial No. 2018-123558, filed on Jun. 28, 2018. The entirety of the above-mentioned patent applications is hereby incorporated by reference herein and made a part of this specification.

### BACKGROUND

### Technical Field

The present disclosure relates to a rubber composition, and a paper feeding roller that includes a roller main body formed by using the rubber composition.

### Description of Related Art

For example, a paper feeding roller is used for carrying (passing) sheets such as paper and plastic film, in various equipment such as an image forming apparatus such as a laser printer using electrophotography, an inkjet printer, an image scanner, or an automated teller machine (ATM).

Examples of the paper feeding roller include a paper supply roller, a carrying roller, a platen roller, a paper discharging roller, and the like, which rotate while coming into contact with the sheet so as to allow the sheet to pass through by friction.

The paper feeding roller is generally made of an elastic body such as rubber or soft resin, and is configured such that a shaft made of metal or the like is inserted through a through hole of a roller main body having a through hole through which the shaft is inserted, and the shaft is fixed thereto.

In recent years, the above-mentioned equipment has been required to have higher durability than had been the case, and a paper feeding roller has been required to have further improved abrasion resistance in the roller main body.

It is known that when a urethane rubber is used as an elastic body, it is possible to form a roller main body having excellent abrasion resistance.

However, there is a problem that because a urethane rubber has a low frictional coefficient with respect to a sheet, it may not be possible to ensure a favorable paper feeding performance in a paper feeding roller; and that because urethane rubber is relatively expensive, there are cost pressures in manufacturing a paper feeding roller.

The roller main body is further required to have, in addition to abrasion resistance, for example, excellent ozone resistance, weather fastness, and the like for being used in image forming apparatuses, or to have excellent weather fastness, heat aging resistance, cold resistance, low-temperature characteristics, and the like in order to exhibit stable performance in an ATM installed in various places.

For this reason, a paper feeding roller in which the roller main body is formed by using ethylene propylene diene rubber (EPDM), which is cheaper than urethane rubber, has become widespread (refer to Patent Document 1 (Japanese Patent Laid-Open No. 2014-196428) and Patent Document 2 (Japanese Patent Laid-Open No. 2015-107877), and the like), because even though a roller main body is inferior than with urethane rubber in terms of abrasion resistance, the roller main body is excellent in terms of the above characteristics.

Among paper feeding rollers, a paper supply roller that separates sheets of paper stacked in a sheet tray one at a time and supplies the sheets is required to have a high frictional coefficient with respect to the sheets, and to have an excellent paper feeding performance.

In order to improve the paper feeding performance of a paper feeding roller, it is common to lower a rubber hardness in the roller main body to increase the flexibility thereof, but particularly in a case of a roller main body made of EPDM, the problem that, as rubber hardness decreases, abrasion resistance decreases, arises.

In addition, in order to improve the paper feeding performance, another rubber such as isoprene rubber (IR) may be blended with EPDM, but in this case, weather fastness and abrasion resistance of the roller main body tend to further decrease.

In Patent Document 1, two kinds of EPDM having different ethylene contents are used in combination as a rubber in order to achieve both favorable abrasion resistance and excellent paper feeding performance.

However, in all of the paper feeding rollers manufactured in respective examples of Patent Document 1, a type A durometer hardness of the roller main body is 60 or more, which indicates low flexibility, and the paper feeding performance is not sufficient to the extent that a paper feeding roller could be used specifically as a paper supply roller or the like, and therefore further improvement is required. The disclosure provides a rubber composition which is a base of a roller main body and capable of imparting favorable flexibility to the roller main body while maintaining high abrasion resistance to form, for example, a paper feeding roller that has a favorable paper feeding performance and can be used as a paper supply roller or the like.

The disclosure further provides a paper feeding roller in which a roller main body is formed using the above-mentioned rubber composition.

### SUMMARY

According to an embodiment, there is provided a rubber composition for forming a roller main body of a paper feeding roller, the rubber composition containing: a rubber that includes at least EPDMs; 20 parts by mass or less of a filler per 100 parts by mass of a total amount of the rubber; and 2.5 parts by mass or more of a peroxide crosslinking agent per 100 parts by mass of the total amount of the rubber, in which the EPDMs are a non-oil extended EPDM having an ethylene content of 55% or more and 72% or less, and an oil extended EPDM, and a proportion of the non-oil extended EPDM is 20 parts by mass or more and 80 parts by mass or less with respect to 100 parts by mass of the total amount of the rubber.

According to another embodiment, there is provided a paper feeding roller that includes a roller main body made of this rubber composition.

### BRIEF DESCRIPTION OF THE DRAWINGS

FIG. 1 is an enlarged perspective view showing a part of a paper feeding roller of the present disclosure, which is an example of an embodiment.

FIG. 2 is a view for explaining a method of measuring a frictional coefficient of a paper feeding roller in order to evaluate a paper feeding performance of the paper feeding roller formed by using a rubber composition of an example and a comparative example of the present disclosure.

### DESCRIPTION OF THE EMBODIMENTS

According to the present disclosure, it is possible to provide a rubber composition which is a base of a roller main body and capable of imparting favorable flexibility to the roller main body while maintaining high abrasion resistance to form, for example, a paper feeding roller that has a favorable paper feeding performance and can be used as a paper supply roller or the like.

According to the present disclosure, it is possible to further provide a paper feeding roller in which a roller main body is formed using the above-mentioned rubber composition.

<<Rubber Composition>>

As described above, a rubber composition of the present disclosure contains: a rubber that includes at least EPDMs; 20 parts by mass or less of a filler per 100 parts by mass of a total amount of the rubber; and 2.5 parts by mass or more of a peroxide crosslinking agent per 100 parts by mass of the total amount of the rubber, in which the EPDMs are a non-oil extended EPDM having an ethylene content of 55% or more and 72% or less, and an oil extended EPDM, and a proportion of the non-oil extended EPDM is 20 parts by mass or more and 80 parts by mass or less with respect to 100 parts by mass of the total amount of the rubber.

According to the rubber composition of the present disclosure, by blending the above-mentioned respective components at a predetermined ratio, flexibility of the roller main body is improved while maintaining high abrasion resistance of the roller main body, and therefore it is possible to form a paper feeding roller that has a favorable paper feeding performance and can be used as a paper supply roller and the like.

This can also be clearly understood based on the results of examples and comparative examples to be described later.

In the present disclosure, regarding an oil extended rubber such as an oil extended EPDM, an amount of solid contents (rubber content) in the oil extended rubber is defined as an amount of rubber, thereby obtaining a total amount of rubber, which is a reference for a proportion of each component, and a proportion of each component of rubbers and components other than rubbers.

<Rubber>

As a rubber, a rubber including at least EPDMs is used as described above.

In addition, for the EPDMs, a non-oil extended EPDM having an ethylene content within the above-mentioned range and an oil extended EPDM may be used in combination among various EPDMs into which double bonds are introduced by adding a small amount of a third component (diene) to ethylene and propylene.

Examples of dienes include ethylidene norbornene (ENB), dicyclopentadiene (DCPD), and the like.

(Non-Oil Extended EPDM)

The reason why an ethylene content of the non-oil extended EPDM is limited to 55% or more and 72% or less is as follows.

That is, when a non-oil extended EPDM having an ethylene content of less than this range is used, the abrasion resistance of the roller main body deteriorates.

On the other hand, when a non-oil extended EPDM having an ethylene content exceeding the above-mentioned range is used, a viscosity of the rubber composition before crosslinking at the time of heating and melting increases, and therefore workability of the rubber composition deteriorates.

In addition, there is a problem that it is difficult to prepare a rubber composition by blending in each of the above-mentioned components, or to produce a roller main body by molding the prepared rubber composition into, for example, a cylindrical shape.

On the other hand, by selecting and using a non-oil extended EPDM having an ethylene content within the above-mentioned range, it is possible to form a roller main body having excellent abrasion resistance while maintaining favorable workability for the rubber composition.

Specific examples of non-oil extended EPDMs having an ethylene content within the above-mentioned range are not limited thereto, and for example, it is possible to use one or two or more of the various non-oil extended EPDMs described below.

ESPRENE (registered trademark) (manufactured by Sumitomo Chemical Co., Ltd.) Series 301 [ethylene content: 62%, diene content: 3.0%], 502 [ethylene content: 56%, diene content: 4.0%], 512F [ethylene content: 65%, diene content: 4.0%], 552 [ethylene content: 55%, diene content: 4.0%], 553 [ethylene content: 58%, diene content: 4.5%], and 586 [ethylene content: 66%, diene content: 12.5%].

NORDEL (registered trademark) (manufactured by Dow Chemical Company) Series IP 3640 [ethylene content: 55%, diene content: 1.8%], IP 3720P [ethylene content: 70%, diene content: 0.6%], IP 3722P [ethylene content: 71%, diene content: 0.5%], IP 3745P [ethylene content: 70%, diene content: 0.5%], IP 3760P [ethylene content: 67% diene content: 2.2%], IP 4640 [ethylene content: 55%, diene content: 4.9%], IP 4725P [ethylene content: 70%, diene content: 4.9%], IP 4760P [ethylene content: 67% diene content: 4.9%], IP 4770R [ethylene content: 70%, diene content: 4.9%], IP 4770P [ethylene content: 70%, diene content: 4.9%], IP 4785HM [ethylene content: 68%, diene content: 4.9%], IP 3722P EL [ethylene content: 71%, diene content: 0.5%], IP 3745P EL [ethylene content: 70%, diene content: 0.5%], IP 4770P EL [ethylene content: 70%, diene content: 4.9%], and IP 4770R EL [ethylene content: 70%, diene content: 4.9%].

EP21 [ethylene content: 61%, diene content: 5.8%], EP51 [ethylene content: 67%, diene content: 5.8%], EP25 [ethylene content: 58.5%, diene content: 5.1%], EP123 [ethylene content: 58%, diene content: 4.5%], EP103AF [ethylene content: 59%, diene content: 4.5%], EP107F [ethylene content: 62%, diene content: 4.5%], EP57F/C [ethylene content: 67%, diene content: 4.5%], and EP93 [ethylene content: 55%, diene content: 2.7%] which are manufactured by JSR Corporation.

Mitsui EPT (manufactured by Mitsui Chemicals, Inc.) Series 1045 [ethylene content: 58%, diene content: 5.0%], 1070 [ethylene content: 57%, diene content: 4.0%], 2060M [ethylene content: 55%, diene content: 2.3%], 3045 [ethylene content: 56%, diene content: 4.7%], 3070 [ethylene content: 58%, diene content: 4.7%], 3091 [ethylene content: 61%, diene content: 5.4%], 3092M [ethylene content: 65%, diene content: 4.6%], 3110M [ethylene content: 56%, diene content: 5.0%], 4070 [ethylene content: 56%, diene content: 8.1%], X-3012P [ethylene content: 72%, diene content: 3.6%], and 3092PM [ethylene content: 65%, diene content: 4.6%].

The reason why a proportion of the non-oil extended EPDM is limited to 20 parts by mass or more and 80 parts by mass or less with respect to 100 parts by mass of the total amount of rubber is as follows.

That is, in a case where a proportion of the non-oil extended EPDM is less than this range, abrasion resistance of the roller main body deteriorates.

On the other hand, in a case where a proportion of the non-oil extended EPDM exceeds the above-mentioned range, the type A durometer hardness of the roller main body becomes 60 or more, and therefore flexibility of the roller main body deteriorates.

For this reason, a paper feeding roller including this roller main body has insufficient paper feeding performance for use as a paper supply roller or the like.

On the other hand, by setting a proportion of the non-oil extended EPDM to be within the above-mentioned range, flexibility of the roller main body is improved while maintaining high abrasion resistance of the roller main body, and therefore it is possible to form a paper feeding roller that has a favorable paper feeding performance and can be used as a paper supply roller or the like.

(Oil Extended EPDM)

In order to impart flexibility to a roller main body, in general, a process oil is blended with the rubber and kneaded until becoming uniformly mixed.

However, in order to form a roller main body having high flexibility such that the type A durometer hardness is less than 60, it is necessary to blend a large amount of process oil into the rubber composition.

In the case of the present disclosure, because an amount of the filler contributing to kneading is small, a long kneading time is required to uniformly mix in a large amount of process oil, and thus workability of kneading deteriorates in some cases.

In addition, a large amount of process oil may bleed to an outer peripheral surface of the roller main body, and this is a cause of a deterioration in the paper feeding performance of the paper feeding roller.

On the contrary, in the present disclosure, a kneading time is shortened by blending the oil extended EPDM with which an extender oil has become already mixed, and therefore workability of kneading can be improved.

In addition, an appropriate amount of extender oil contained in the oil extended EPDM does not bleed to the outer peripheral surface of the roller main body.

Therefore, in the present disclosure, it is preferable not to blend in (exclude) a process oil such as paraffin oil, and even when an oil has been blended in, it is preferable to set a content of the oil to about 2 parts by mass or less with respect to 100 parts by mass of the total amount of rubber content.

As the oil extended EPDM, it is possible to use various oil extended EPDMs obtained by extending a raw material EPDM by an arbitrary proportion using any extension oil.

However, as the raw material EPDM, which is a base of the oil extended EPDM, it is preferable to select and use an EPDM in which an ethylene content is 55% or more and 72% or less in order to maintain the effects of limiting an ethylene content of the non-oil extended EPDM as described above.

Examples of the extender oil include a paraffin oil and the like.

An oil extended amount of the extender oil is not particularly limited, and is preferably 70 parts by mass (70 phr) or more, and preferably 150 parts by mass (150 phr) or less per 100 parts by mass of EPDMs.

An oil extended EPDM that satisfies these conditions is not limited thereto, and for example, it is possible to use one or two or more of the various oil extended EPDMs described below.

ESPRENE (manufactured by Sumitomo Chemical Co., Ltd.) Series 6101 [ethylene content: 70%, diene content: 6.5%, oil extended amount: 70 phr], 601F [ethylene content: 59%, diene content: 3.5%, oil extended amount: 70 phr], 600F [ethylene content: 66%, diene content: 4.0%, oil extended amount: 100 phr], and 670F [ethylene content: 66%, diene content: 4.0%, oil extended amount: 100 phr].

EP98 [ethylene content: 66%, diene content: 4.5%, oil extended amount: 75 phr] manufactured by JSR Corporation.

Mitsui EPT X-3042E [ethylene content: 66%, diene content: 4.7%, oil extended amount: 120 phr] manufactured by Mitsui Chemicals, Inc.

As described above, a proportion of the oil extended EPDM in which an amount of solid contents (EPDM as rubber content) contained in the oil extended EPDM is defined as an amount of rubber, is preferably 10 parts by mass or more and preferably 80 parts by mass or less with respect to 100 parts by mass of the total amount of rubber.

In a case where a proportion of the oil extended EPDM is less than this range, there is a case in which effects of imparting a favorable paper feeding performance to the paper feeding roller by increasing flexibility of the roller main body so that the paper feeding roller can be used as a paper supply roller or the like, cannot be obtained.

On the other hand, in a case where a proportion of the oil extended EPDM exceeds the above-mentioned range, a proportion of the non-oil extended EPDM relatively decreases, and therefore abrasion resistance of the roller main body decreases in some cases.

On the other hand, by setting a proportion of the oil extended EPDM to be within the above-mentioned range, flexibility of the roller main body is improved while maintaining high abrasion resistance of the roller main body, and therefore it is possible to form the paper feeding roller that has a favorable paper feeding performance and can be used as a paper supply roller or the like.

In consideration of further improving these effects, a proportion of the oil extended EPDM is preferably 15 parts by mass or more, and preferably 70 parts by mass or less, particularly preferably 60 parts by mass or less in the above-mentioned range.

(Other Rubbers)

As the rubber, other rubbers may be used in combination as long as the effect of the present disclosure is not impaired.

As other rubbers, it is possible to use one or two or more kinds of, for example, natural rubbers, IR, a butadiene rubber (BR), a styrene butadiene rubber (SBR), an acrylonitrile butadiene rubber (NBR), a fluororubber (FKM), a chloroprene rubber (CR), a silicone rubber (VMQ), and the like.

As other rubbers, any of a non-oil extended rubber or an oil extended rubber may be used.

IR which functions to increase a frictional coefficient of a roller main body made of EPDMs with respect to paper to improve the paper feeding performance of the paper feeding roller, is particularly preferable.

As IR, any of various polymers having a polyisoprene structure can be used.

Examples of IR include, but are not limited to, at least one of Nipol (registered trademark) IR2200, IR2200R, and the like manufactured by Zeon Corporation.

In a case where IR is used alone as another rubber (including a case where two or more IRs are used in combination), a proportion of the IR is preferably 10 parts by mass or more, particularly preferably 20 parts by mass or more, and is preferably 60 parts by mass or less, particularly preferably 50 parts by mass or less with respect to 100 parts by mass of the total amount of the rubber.

In a case where a proportion of IR is less than this range, effects of improving the paper feeding performance of the paper feeding roller by increasing a frictional coefficient of the roller main body made of EPDMs with respect to paper and by blending in the IR, are not sufficiently exhibited in some cases.

On the other hand, in a case where a proportion of IR exceeds the above-mentioned range, a proportion of EPDMs relatively decreases, and therefore ozone resistance and weather fastness of the roller main body deteriorate in some cases.

On the other hand, by setting a proportion of IR within the above-mentioned range, it is possible to further improve the paper feeding performance of the paper feeding roller by increasing a frictional coefficient of the roller main body with respect to paper while inhibiting a deterioration in the ozone resistance and weather fastness of the roller main body.

A remaining amount of rubber is non-oil extended EPDMs and oil extended EPDMs.

That is, a total proportion of non-oil extended EPDMs and oil extended EPDMs is preferably 40 parts by mass or more, particularly preferably 50 parts by mass or more, and preferably 90 parts by mass or less, particularly preferably 80 parts by mass or less with respect to 100 parts by mass of the total amount of rubber.

A proportion of other rubbers such as IR is a proportion of non-oil extended rubbers in the case where the other rubbers are non-oil extended rubbers, and a proportion of other rubbers is a proportion of the rubber content as solid contents, which is contained in oil extended rubbers, in the case of oil extended rubbers as described above.

The rubber may be a rubber in which rubbers other than IR are not contained, and the total amount of rubber is that of non-oil extended EPDMs and oil extended EPDMs, that is, a total proportion of non-oil extended EPDMs and oil extended EPDMs which is 100 parts by mass.

However, in this case, a proportion of non-oil extended EPDMs is limited to 80 parts by mass or less.

<Filler>

As the filler, one or two or more fillers such as carbon black, calcium carbonate, zinc oxide, silica, clay, talc, magnesium carbonate, aluminum hydroxide, and titanium oxide can be used.

The reason that a proportion of the filler is limited to 20 parts by mass or less per 100 parts by mass of the total amount of the rubber is that, in a case where a proportion of the filler exceeds this range, flexibility of the roller main body is reduced, and therefore it is impossible to form the paper feeding roller that has a favorable paper feeding performance and can be used as a paper supply roller or the like.

On the other hand, by setting a proportion of the filler to be within the above-mentioned range, flexibility of the roller main body is improved, and therefore it is possible to form the paper feeding roller that has a favorable paper feeding performance and can be used as a paper supply roller or the like.

In consideration of further improving such effects, a proportion of the filler is preferably 16 parts by mass or less per 100 parts by mass of the total amount of the rubber, in the above-mentioned range.

In addition, a proportion of the filler is preferably 1 part by mass or more, particularly preferably 3 parts by mass or more per 100 parts by mass of the total amount of the rubber, in the above-mentioned range.

The filler contributes to the kneading of the rubber composition as described above, but because such effects cannot be sufficiently obtained when a proportion of the filler is less than the above-mentioned range, it is difficult for the rubber to gather at the time of kneading, and therefore workability of kneading deteriorates in some cases.

In addition, functions of the filler as a bulking agent and reinforcing agent cannot be sufficiently obtained, strength of the roller main body is lowered, and therefore breakage or the like becomes likely to occur at the time of using the paper feeding roller in some cases.

On the other hand, by setting a proportion of the filler within the above-mentioned range, it is possible to improve workability of kneading due to shortening of a kneading time, or it is possible that breakage or the like will become unlikely to occur at a time of using a paper feeding roller due to improving the strength of the roller main body.

<Peroxide Crosslinking Agent>

The peroxide crosslinking agent is not limited to the following examples. It is possible to use, for example, one of two or more of benzoyl peroxide, 1,1-bis(tert-butylperoxy)-3,3,5-trimethylcyclohexane, 2,5-dimethyl-2,5-di(benzoylperoxy)hexane, di(tert-butylperoxy)diisopropylbenzene, 1,4-bis [(tertbutyl)peroxyisopropyl] benzene, di(tert-butylperoxy) benzoate, tert-butyl peroxybenzoate, dicumyl peroxide, tert-butyl cumyl peroxide, 2,5-dimethyl-2,5-di(tert-butylperoxy)hexane, di-tert-butyl peroxide, 2,5-dimethyl-2,5-di(tert-butylperoxy)-3-hexene, and the like.

The reason that a proportion of the peroxide crosslinking agent is limited to 2.5 parts by mass or more per 100 parts by mass of the total amount of rubber is because when a proportion of the peroxide crosslinking agent is less than this range, abrasion resistance of the roller main body deteriorates.

On the other hand, by setting a proportion of the peroxide crosslinking agent within the above-mentioned range, abrasion resistance of the roller main body can be improved.

In consideration of further improving such effects, a proportion of the peroxide crosslinking agent is preferably 2.8 parts by mass or more per 100 parts by mass of the total amount of the rubber, in the above-mentioned range.

In addition, a proportion of the peroxide crosslinking agent is preferably 5 parts by mass or less, particularly preferably 4 parts by mass or less per 100 parts by mass of the total amount of the rubber, in the above-mentioned range.

In a case where a proportion of the peroxide crosslinking agent exceeds this range, the rubber composition scorches at the time of molding, flexibility of the roller main body deteriorates, and therefore it is impossible to form the paper feeding roller that has a favorable paper feeding performance and can be used as a paper supply roller or the like in some cases.

On the other hand, by setting a proportion of the peroxide crosslinking agent to be within the above-mentioned range, flexibility of the roller main body is improved while inhibiting scorching of the rubber composition, and therefore it is possible to form the paper feeding roller that has a favorable paper feeding performance and can be used as a paper supply roller or the like.

<Other Components>

Components to be generally blended into the rubber composition, such as an antioxidant, a co-crosslinking agent, a pigment, a plasticizer, and a processing aid, may be added to the rubber composition, at an appropriate amount not impairing the effects of the present disclosure.

<<Paper Feeding Roller>>

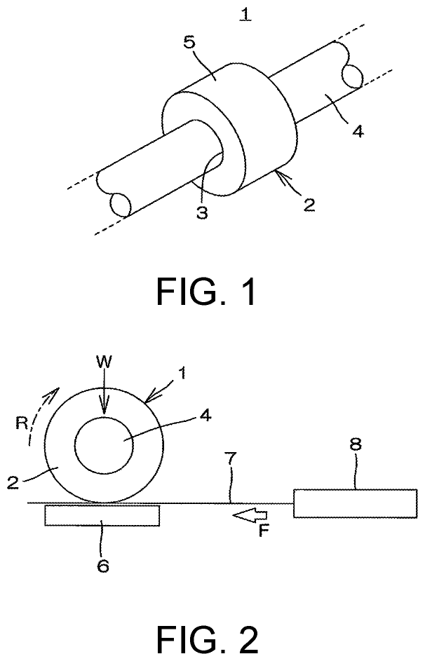

FIG. 1 is a perspective view showing the paper feeding roller of the present disclosure, which is an example of an embodiment.

Referring to FIG. 1, a paper feeding roller 1 of this example includes a roller main body 2 formed by molding the above-described rubber composition of the present disclosure into a tubular shape and crosslinking.

A through hole 3 having a circular cross-section is provided at the center of the roller main body 2, and a shaft 4 having a columnar shape, which is linked to a driving system (not shown), is inserted into the through hole 3 so as to be fixed.

An outer peripheral surface 5 of the roller main body 2, which comes in contact with a sheet, is formed in a cylindrical shape concentric with the through hole 3 and the shaft 4 in the example of the drawing.

The roller main body 2 and the shaft 4 are fixed to each other by, for example, press-fitting the shaft 4 having a larger outer diameter than an inner diameter of the through hole 3 into the through hole 3 of the roller main body 2 so that idling does not occur.

In other words, due to an interference based on a difference in diameter between the roller main body 2 and the shaft 4, a certain idle torque (limit torque which does not cause idling) is secured therebetween.

The shaft 4 is made of, for example, metal, ceramic, hard resin, or the like.

A plurality of roller main bodies 2 may be fixed to a plurality of locations on one shaft 4, if necessary.

The roller main body 2 is manufactured by, for example, molding the rubber composition into a tubular shape by extrusion molding or the like, and then crosslinking by a press crosslinking method or the like; or by molding the rubber composition into a tubular shape by a transfer molding method or the like and crosslinking at the same time.

If necessary, the outer peripheral surface 5 of the roller main body 2 may be polished so as to have a predetermined surface roughness, or may be subjected to knurl processing, surface texturing, or the like at any point in the manufacturing process.

Alternatively, both ends of the roller main body 2 may be cut so that the outer peripheral surface 5 has a predetermined width.

The outer peripheral surface 5 of the roller main body 2 may be coated with any coating layer.

Alternatively, the roller main body 2 may be formed to have a two-layer structure of an outer layer on the outer peripheral surface 5 side and an inner layer on the through hole 3 side.

In this case, at least the outer layer is preferably formed of the rubber composition of the present disclosure.

However, when considering simplifying the structure, improving productivity, lowering manufacturing costs, and the like, it is preferable that the roller main body 2 have a single-layer structure as shown in FIG. 1.

In addition, the roller main body 2 may have a porous structure.

However, in order that concavities due to deformation become unlikely to occur due to improving abrasion resistance and reducing compression even if a state of contact at one point continues for a relatively long period of time, the roller main body 2 preferably has a substantially nonporous structure.

In a case where the paper feeding roller 1 is used as a paper supply roller or the like as described above, it is preferable that the roller main body 2 have a type A durometer hardness of less than 60 for favorable paper feeding.

In addition, when considering improvement in abrasion resistance and reduction in compression set as described above, the roller main body 2 preferably has a type A durometer hardness of 20 or more, particularly preferably 40 or more.

Depending on the application of the paper feeding roller 1, the through hole 3 may be provided at a position eccentric from the center of the roller main body 2.

In addition, the outer peripheral surface 5 of the roller main body 2 may have not only a tubular shape, but also an irregular shape, for example, a shape in which a part of the tubular outer peripheral surface is cut out into a planar shape.

In order to manufacture the paper feeding roller 1 including the roller main body 2 with these irregular shapes, the roller main body 2 having an irregular shape may be directly formed by the above-described manufacturing method and then crosslinked, or the roller main body 2 formed into a tubular shape may be made to have an irregular shape by post-processing.

In addition, the roller main body 2 may be deformed into an irregular shape by press-fitting the shaft 4 which has been made to have a deformed shape corresponding to an irregular shape of the roller main body 2, into the through hole 3 of the roller main body 2 formed into a tubular shape.

In this case, polishing, knurl processing, surface texturing, and the like of the outer peripheral surface 5 can be performed on the tubular outer peripheral surface 5 before deformation, and therefore workability can be improved.

<<Image Forming Apparatus>>

The paper feeding roller of the present disclosure can be incorporated into various image forming apparatuses which use electrophotography, such as laser printers, electrostatic copying machines, plain paper facsimile machines, or multifunction machines thereof.

Furthermore, the paper feeding roller of the present disclosure can also be incorporated into, for example, an ink jet printer, an ATM, or the like.

The paper feeding roller of the present disclosure can be used as, for example, a paper supply roller, a carrying roller, a platen roller, a paper discharging roller, or the like, which rotate while coming into contact with paper to carry the paper by friction. The paper feeding roller is particularly preferably used as the paper supply roller as described above.

In the paper feeding roller of the present disclosure, flexibility of the roller main body is excellent, and therefore a favorable paper feeding performance can be exhibited when being used as the paper supply roller.

In addition, in the paper feeding roller of the present disclosure, abrasion resistance of the roller main body is also excellent, and therefore it is possible to extend the life of the roller to more than that in present circumstances to reduce a frequency of replacement, and to realize the high durability required for an image forming apparatus and the like.

### EXAMPLES

Hereinafter, the present disclosure will be further explained based on examples and comparative examples, but the constitution of the present disclosure is not limited by these examples.

### Example 1

(Preparation of Rubber Composition)

As a rubber, 75 parts by mass of the non-oil extended EPDM [NORDEL IP 4770R manufactured by Dow Chemical Company, ethylene content: 70%, diene content: 4.9%] and 50 parts by mass of the oil extended EPDM [ESPRENE 670F manufactured by Sumitomo Chemical Co., Ltd., ethylene content: 66%, diene content: 4.0%, oil extended amount: 100 phr] (solid contents: 25 parts by mass) were used.

5 parts by mass of carbon black [HAF, trade name SEAST 3, manufactured by Tokai Carbon Co., Ltd.] as a filler and 3 parts by mass of dicumyl peroxide [percumyl (registered trademark) D manufactured by NOF CORPORATION] as a peroxide crosslinking agent were blended into a total amount of 125 parts by mass of both rubbers (total amount of rubber as solid contents was 100 parts by mass), and kneaded using a 3 L kneader and an open roller, and therefore a rubber composition was prepared.

### Example 2

A rubber composition was prepared in the same manner as in Example 1 except that the same amount of NORDEL IP 4725P [ethylene content: 70%, diene content: 4.9%] manufactured by Dow Chemical Company was blended in as the non-oil extended EPDM.

### Example 3

A rubber composition was prepared in the same manner as in Example 1 except that the same amount of EP25 [ethylene content: 58.5%, diene content: 5.1%] manufactured by JSR Corporation was blended in as the non-oil extended EPDM.

### Example 4

A rubber composition was prepared in the same manner as in Example 1 except that 55 parts by mass of the non-oil extended EPDM [ESPRENE 586 manufactured by Sumitomo Chemical Co., Ltd., ethylene content: 66%, diene content: 12.5%], 30 parts by mass of the oil extended EPDM [ESPRENE 670F manufactured by Sumitomo Chemical Co., Ltd., ethylene content: 66%, diene content: 4.0%, oil extended amount: 100 phr] (solid contents: 15 parts by mass), and 30 parts by mass of IR [Nipol IR2200 manufactured by Zeon Corporation] were blended in as the rubber.

### Example 5

A rubber composition was prepared in the same manner as in Example 4 except that an amount of the non-oil extended EPDM was 20 parts by mass, an amount of the oil extended EPDM was 120 parts by mass (solid contents: 60 parts by mass), and an amount of the IR was 20 parts by mass, and that a total of 15.2 parts by mass of 0.2 parts by mass of carbon black [HAF, trade name SEAST 3 manufactured by Tokai Carbon Co., Ltd.], 5 parts by mass of zinc oxide [manufactured by Shiraishi Calcium Kaisha, Ltd.], and 10 parts by mass of calcium carbonate [heavy calcium carbonate, Softon 3200 manufactured by Shiraishi Calcium Kaisha, Ltd.] were blended in as a filler.

### Example 6

A rubber composition was prepared in the same manner as in Example 5 except that an amount of the non-oil extended EPDM was 20 parts by mass, an amount of the oil extended EPDM was 40 parts by mass (solid contents: 20 parts by mass), an amount of the IR was 60 parts by mass, and that an amount of zinc oxide was 10 parts by mass, and an amount of calcium carbonate was 5 parts by mass.

### Comparative Example 1

A rubber composition was prepared in the same manner as in Example 1 except that the same amount of ESPRENE 505A [ethylene content: 50%, diene content: 9.5%] manufactured by Sumitomo Chemical Co., Ltd. was blended in as the non-oil extended EPDM.

### Comparative Example 2

A rubber composition was prepared in the same manner as in Example 1 except that 30 parts by mass of the non-oil extended EPDM [ESPRENE 505A manufactured by Sumitomo Chemical Co., Ltd., ethylene content: 50%, diene content: 9.5%], 100 parts by mass of the oil extended EPDM [ESPRENE 670F manufactured by Sumitomo Chemical Co., Ltd., ethylene content: 66%, diene content: 4.0%, oil extended amount: 100 phr] (solid contents: 50 parts by mass), and 20 parts by mass of IR [Nipol IR2200 manufactured by Zeon Corporation] were blended in as the rubber.

### Comparative Example 3

A rubber composition was prepared in the same manner as in Example 1 except that 10 parts by mass of the non-oil extended EPDM [NORDEL IP 4770R manufactured by Dow Chemical Company, ethylene content: 70%, diene content: 4.9%], 140 parts by mass of the oil extended EPDM [ESPRENE 670F manufactured by Sumitomo Chemical Co., Ltd., ethylene content: 66%, diene content: 4.0%, oil extended amount: 100 phr] (solid contents: 70 parts by mass), and 20 parts by mass of IR [Nipol IR2200 manufactured by Zeon Corporation] were blended in as the rubber.

### Comparative Example 4

A rubber composition was prepared in the same manner as in Example 5 except that 160 parts by mass of the oil extended EPDM [ESPRENE 670F manufactured by Sumitomo Chemical Co., Ltd., ethylene content: 66%, diene content: 4.0%, oil extended amount: 100 phr](solid contents: 80 parts by mass), and 20 parts by mass of IR [Nipol IR2200 manufactured by Zeon Corporation] were blended in as the rubber; and that the non-oil extended EPDM was not blended in.

### Comparative Example 5

A rubber composition was prepared in the same manner as in Example 5 except that an amount of the non-oil extended EPDM was 30 parts by mass, an amount of the oil extended EPDM was 100 parts by mass (solid contents: 50 parts by mass), an amount of the IR was 20 parts by mass, and an amount of the peroxide crosslinking agent was 2.1 parts by mass.

<Hardness Test>

The rubber compositions prepared in Examples 1 to 6 and Comparative Examples 1 to 5 were press-crosslinked under the condition of 170° C. for 20 minutes to form sheets having a thickness of 2 mm, and three sheets thereof were laminated to prepare test pieces.

Using these test pieces, numerical values after 3 seconds were read under the environment of a temperature at 23±2° C. in accordance with a measurement method described in Japan Industrial Standard JIS K 6253-3: 2012 “Method for obtaining hardness of vulcanized rubber and thermoplastic rubber—Part 3: Durometer hardness,” and these values were used as a type A durometer hardness.

<Ozone Resistance Test>

The rubber compositions prepared in Examples 1 to 6 and Comparative Examples 1 to 5 were press-crosslinked under the conditions of 170° C. for 20 minutes to form sheets having a thickness of 2 mm, and were punched so as to prepare a strip-shaped test piece having a width of 10 mm and a length of 100 mm prescribed in Japanese Industrial Standards JIS K 6259-1: 2015 “Method for obtaining ozone resistance of vulcanized rubber and thermoplastic rubber—Part 1: Static ozone degradation test and dynamic ozone degradation test.”

Next, whether or not cracks (ozone cracks) were generated when the produced test pieces were exposed to ozone under conditions of a temperature of 40° C., an ozone concentration of 50 ppm, and a test time of 72 hours while applying tensile strain (20% elongation) to the test pieces, was checked.

Then, a test piece in which no cracks were generated was evaluated as good, “0,” and a test piece in which cracks were generated was evaluated as poor, “X.”

<Production of Paper Feeding Roller>

The rubber compositions prepared in Examples 1 to 6 and Comparative Examples 1 to 5 were transfer-molded into a tubular shape under conditions of 170° C. for 20 minutes, and while being in a state where the shaft 4 with an outer diameter of 17 mm was pressed into the through hole 3, the transfer-molded rubber compositions were polished so as to have an outer diameter of 23 mm by using a cylindrical grinding machine, and then cut to have a width of 30 mm, and therefore a paper feeding roller 1 having a tubular roller main body 2 was produced.

<Frictional Coefficient Test>

As shown in FIG. 2, the roller main body 2 of the produced paper feeding roller 1 was pressed, while applying a vertical load W (=300 gf), on a paper 7 having a width of 60 mm and a length of 210 mm [P paper (plain paper) manufactured by Fuji Xerox Co., Ltd.] placed on a plate 6 made of polytetrafluoroethylene (PTFE) which was horizontally installed.

Next, a carrying force F (gf) applied to a load cell 8 in contact with one end of the paper 7 was measured when the roller main body 2 was rotated at 200 rpm in a direction indicated by a single dot-dashed line arrow R in an environment of a temperature of 23±2° C. and a relative humidity of 55±10%.

Next, a frictional coefficient μ was obtained from the measured carrying force F and the vertical load W (=300 gf) by Formula (1):

μ=F(gf)/W(gf) (1)

Then, a test piece in which a frictional coefficient μ was 1.5 or more was evaluated as good, “O,” and a test piece in which a frictional coefficient μ was less than 1.5 was evaluated as poor, “X.”

<Abrasion Resistance Test>

In the same manner as in the above-described frictional coefficient test, as shown in FIG. 2, the roller main body 2 of the produced paper feeding roller 1 was pressed, while applying a vertical load W (=500 gf), on the paper 7 having a width of 60 mm and a length of 210 mm [P paper (plain paper) manufactured by Fuji Xerox Co., Ltd.] placed on the plate 6 made of polytetrafluoroethylene (PTFE) which was horizontally installed.

Next, the roller main body 2 was continuously rotated at 200 rpm for 10 minutes in the direction indicated by the single dot-dashed line arrow R in an environment of temperature of 23±2° C. and a relative humidity of 55±10%.

Next, a mass of the roller main body (mass after abrasion) was weighed after continuous rotation, and an abrasion rate was obtained from a mass (g) after abrasion and an initial mass (g) of the roller main body weighed before continuous rotation by Formula (2):

Abrasion rate (%)=(initial mass−mass after abrasion)/(initial mass)×100 (2)

Then, a test piece in which an abrasion rate was 0.1% or less was evaluated as good, “O,” and a test piece in which an abrasion rate was more than 0.1% was evaluated as poor, “X.”

The above results are shown in Table 1 and Table 2.

TABLE 1

| | | | Example 1 | Example 2 | Example 3 | Example 4 | Example 5 | Example 6 |
|---|---|---|---|---|---|---|---|---|
| Components | Non-oil | Ethylene | 70 | 70 | 58.5 | 66 | 66 | 66 |
| | extended | content (%) | | | | | | |
| | EPDM | Parts by mass | 75 | 75 | 75 | 55 | 20 | 20 |
| | Oil extended EPDM | | 50 | 50 | 50 | 30 | 120 | 40 |
| | (parts by mass) | | [25] | [25] | [25] | [15] | [60] | [20] |
| | [solid content (parts by | | | | | | | |
| | mass)] | | | | | | | |
| | IR (parts by mass) | | — | — | — | 30 | 20 | 60 |
| | Filler | Carbon black | 5 | 5 | 5 | 5 | 0.2 | 0.2 |
| | (parts by | Zinc oxide | — | — | — | — | 5 | 10 |
| | mass) | Calcium | — | — | — | — | 10 | 5 |
| | | carbonate | | | | | | |
| | | Total | 5 | 5 | 5 | 5 | 15.2 | 15.2 |
| | Peroxide crosslinking agent | | 3 | 3 | 3 | 3 | 3 | 3 |
| | (parts by mass) | | | | | | | |
| Test | Type A durometer hardness | | 55 | 54 | 50 | 52 | 39 | 42 |
| | Ozone resistance test | | ◯ | ◯ | ◯ | ◯ | ◯ | ◯ |
| | Frictional | Numerical | 1.60 | 1.66 | 1.84 | 1.84 | 1.88 | 2.34 |
| | coefficient μ | value | | | | | | |
| | | Evaluation | ◯ | ◯ | ◯ | ◯ | ◯ | ◯ |
| | Abrasion | Abrasion rate | 0.02 | 0.06 | 0.06 | 0.04 | 0.08 | 0.07 |
| | resistance | (%) | | | | | | |
| | | Evaluation | ◯ | ◯ | ◯ | ◯ | ◯ | ◯ |

TABLE 2

| | | | Comparative | Comparative | Comparative | Comparative | Comparative |
|---|---|---|---|---|---|---|---|
| | | | Example 1 | Example 2 | Example 3 | Example 4 | Example 5 |
| Components | Non-oil | Ethylene | 50 | 50 | 70 | — | 66 |
| | extended | content (%) | | | | | |
| | EPDM | Parts by | 75 | 30 | 10 | — | 30 |
| | | mass | | | | | |
| | Oil extended EPDM | | 50 | 100 | 140 | 160 | 100 |
| | (parts by mass) | | [25] | [50] | [70] | [80] | [50] |
| | [solid content (parts by | | | | | | |
| | mass)] | | | | | | |
| | IR (parts by mass) | | — | 20 | 20 | 20 | 20 |
| | Filler | Carbon | 5 | 5 | 5 | 0.2 | 0.2 |
| | (parts by | black | | | | | |
| | mass) | Zinc oxide | — | — | — | 5 | 5 |
| | | Calcium | — | — | — | 10 | 10 |
| | | carbonate | | | | | |
| | | Total | 5 | 5 | 5 | 15.2 | 15.2 |
| | Peroxide crosslinking | | 3 | 3 | 3 | 3 | 2.1 |
| | agent (parts by mass) | | | | | | |
| Test | Type A durometer | | 42 | 36 | 37 | 35 | 40 |
| | hardness | | | | | | |
| | Ozone resistance test | | ◯ | ◯ | ◯ | ◯ | ◯ |
| | Frictional | Numerical | 1.91 | 2.22 | 1.95 | 2.13 | 2.05 |
| | coefficient μ | value | | | | | |
| | | Evaluation | ◯ | ◯ | ◯ | ◯ | ◯ |
| | Abrasion | Abrasion | 0.17 | 0.50 | 0.24 | 0.46 | 0.24 |
| | resistance | rate (%) | | | | | |
| | | Evaluation | X | X | X | X | X |

Based on the results of Examples 1 to 6 and Comparative Examples 1 to 5 of Table 1 and Table 2, it was found that, by forming the roller main body using a rubber composition containing: a rubber that contains 20 to 80 parts by mass of the non-oil extended EPDM having an ethylene content of 55 to 72%, and the oil extended EPDM; 20 parts by mass of a filler per 100 parts by mass of the rubber; and 2.5 parts by mass or more of a peroxide crosslinking agent, favorable flexibility is imparted to the roller main body while maintaining high abrasion resistance, and therefore it is possible to form a paper feeding roller that has a favorable paper feeding performance and can be used as a paper supply roller or the like.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A rubber composition for forming a roller main body of a paper feeding roller, the rubber composition containing:
a rubber that comprises at least an ethylene propylene diene rubber;
20 parts by mass or less of a filler per 100 parts by mass of a total amount of the rubber; and
2.5 parts by mass or more of a peroxide crosslinking agent per 100 parts by mass of the total amount of the rubber,
wherein the ethylene propylene diene rubber is a non-oil extended ethylene propylene diene rubber having an ethylene content of 55% or more and 72% or less, and an oil extended ethylene propylene diene rubber, and
a proportion of the non-oil extended ethylene propylene diene rubber is 20 parts by mass or more and 80 parts by mass or less with respect to 100 parts by mass of the total amount of the rubber.

2. The rubber composition according to claim 1, wherein a proportion of the filler is 1 part by mass or more and 16 parts by mass or less per 100 parts by mass of the total amount of the rubber.

3. The rubber composition according to claim 1, wherein a proportion of the peroxide crosslinking agent is 2.8 parts by mass or more and 5 parts by mass or less per 100 parts by mass of the total amount of the rubber.

4. The rubber composition according to claim 1, further containing an isoprene rubber in the rubber.

5. A paper feeding roller comprising a roller main body that is made of the rubber composition according to claim 1.

6. The paper feeding roller according to claim 5, which is a paper supply roller for separating stacked sheets of paper one at a time to supply the papers.

7. The paper feeding roller according to claim 5, wherein a type A durometer hardness of the roller main body is less than 60.

8. The rubber composition according to claim 1, wherein a proportion of the filler is 1 part by mass or more and 16 parts by mass or less per 100 parts by mass of the total amount of the rubber, a proportion of the peroxide crosslinking agent is 2.8 parts by mass or more and 5 parts by mass or less per 100 parts by mass of the total amount of the rubber.

9. The rubber composition according to claim 1, wherein a proportion of the filler is 1 part by mass or more and 16 parts by mass or less per 100 parts by mass of the total amount of the rubber,
the rubber composition further containing an isoprene rubber in the rubber.

10. The rubber composition according to claim 1, wherein a proportion of the peroxide crosslinking agent is 2.8 parts by mass or more and 5 parts by mass or less per 100 parts by mass of the total amount of the rubber,
the rubber composition further containing an isoprene rubber in the rubber.

11. The rubber composition according to claim 1, wherein a proportion of the filler is 1 part by mass or more and 16 parts by mass or less per 100 parts by mass of the total amount of the rubber, a proportion of the peroxide crosslinking agent is 2.8 parts by mass or more and 5 parts by mass or less per 100 parts by mass of the total amount of the rubber,
the rubber composition further containing an isoprene rubber in the rubber.
